(19) United States
(12) Patent Application Publication
(10) Pub. No.: US 2009/0150326 A1
(43) Pub. Date: Jun. 11, 2009

(54) SMART AGENT FOR EXAMINATION OF AN APPLICATION

(75) Inventor: Kendal Meredith Sheets, Mclean, VA (US)

Correspondence Address: COMPUTER PATENT ANNUITIES NORTH AMERICA, LLC;C/O CPA GLOBAL, P.O. BOX 52050, MINNEAPOLIS, MN, 55402, US

(73) Assignee: FOUNDATIONIP, LLC, Minneapolis, MN (US)

(21) Appl. No.: 12/331,960

(22) Filed: Dec. 10, 2008

Related U.S. Application Data
(60) Provisional application No. 60/996,865, filed on Dec. 10, 2007.

(51) Int. Cl. G06N 7/02

(52) U.S. Cl. 706/52

(57) ABSTRACT

A system, method, and article for profiling an applicant, an examiner, and agency or examination group for the purposes of examination of an application that undergoes a regulated or structured examination. One aspect of the invention can provide a greater degree of predicting success or potential success based on identifying a data factor that has a potential influence upon success of the application. Another aspect uses statistical methods or logic from a fuzzy inference system to analyze data factors. One example is directed towards the filing and prosecution of intellectual property documents such as patent and trademark applications.

### FIELD OF THE INVENTION

This invention relates to profiling applicants and/or examiners and predicting responses for any application that undergoes a regulated or structured examination. The preferred embodiment is directed towards the filing and prosecution of intellectual property documents such as patent and trademark applications.

### BACKGROUND OF THE INVENTION

The filing of an application that undergoes a substantive examination has an inherent lack of predictability due to many factors such as different examining bodies, different subjective interpretation of objective rules or prior law, and different ways that representatives of an application can prosecute the application. In many instances, the application could be worth millions or billions of dollars to a company implementing a commercial product or service under the approval of the application. Reducing the risk of failure of the application is highly valuable to any applicant that spends resources on an application that must substantively examined.

Patent Prosecution by Patent lawyers does not utilize available technology to create the most advantageous position for the applicant. Applicants do not analyze PTO Examiner's work or patent attorneys' success rates. Traditional patent prosecution has changed little in 100 years.

### SUMMARY OF THE INVENTION

The preferred and alternative embodiments of the present invention provide a method and system to predict a response to an application before it is filed, to reduce risk of failure or rejection of the application, and to increase the probability that the application will be approved, thereby reducing resources spend by an applicant through its own efforts or a representative and reducing an applicant's overall commercial risk related to the application.

A smart prosecution database to allow a corporation, applicant, and any patent lawyer anywhere in the work to profile an individual examiner, a technology group within a patent office, or an entire patent office in order to anticipate the Examiner's responses to an application and set of claims before the application is even filed. Will also allow a corporation with a large portfolio to take advantage of attorney success rates against certain examiners or in certain technologies. If the USPTO restricts the number of continuations (that was part of the new rule changes recently enjoined by the Federal Court of Virginia) the ability to anticipate a first office action from an Examiner and the ability to write claims in the most advantageous manner according to what the examiner has allowed in the past will be critical information to have at their disposal. The corporation can also determine which patent attorneys are having the most success against certain examiners or examination groups, allowing the client to pursue claims using the patent attorney having the highest success rates.

### BRIEF DESCRIPTION OF THE DRAWINGS

For a better understanding of the nature of the present invention, its features and advantages, the subsequent detailed description is presented in connection with accompanying drawings in which:

FIG. 1 is a diagram of a network capable of implementing the embodiments;

FIG. 2 is a functional network diagram implementing the embodiments;

FIG. 3 is a functional diagram of data sources, communication, and workflows of the embodiments;

FIG. 4 is a method for using the embodiment; and

FIG. 5 is a block diagram illustrating placement of the components of the hardware tools in a computer system to support the embodiments;

FIG. 6 is a diagram of a generic fuzzy inference system; and

FIG. 7 is a diagram of an exemplary fuzzy inference system of the embodiments.

### DETAILED DESCRIPTION OF THE INVENTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units of the exemplary smart agent system, method, and article embodiments described in this specification have been labeled as managers. A manager may be implemented in programmable hardware devices such as field programmable gate arrays, programmable array logic, programmable logic devices, or the like. The manager may also be implemented in software for execution by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a request manager, an integration manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference is also made throughout of a report created from the underlying data present in the database. In this disclosure, an individual report is an electronic document which represents a particular physical and/or tangible document (e.g. before and/or after the physical/tangible document is converted to and/or from electronic form).

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention. The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

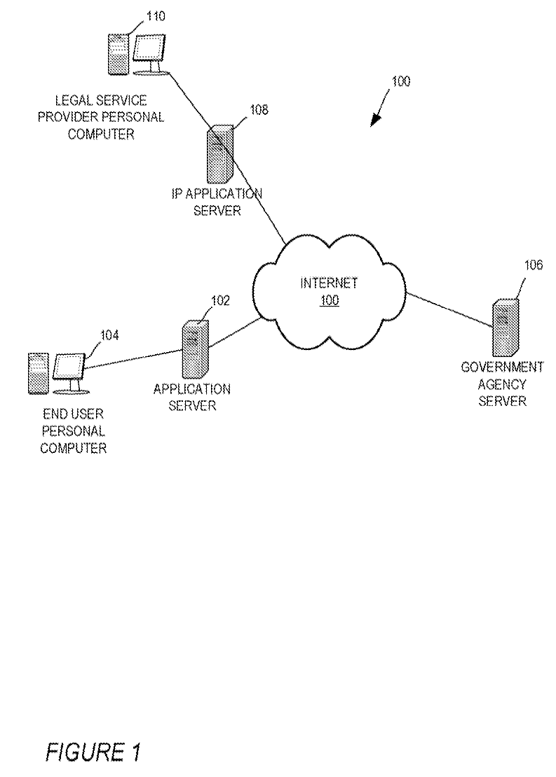

Referring to FIG. 1, a computer network system capable of implementing the preferred and alternative embodiments is illustrated. End users and servers connect to a broadband network, such as the public Internet 100, through managed network lines, and/or a private wide area networks (WAN). Each server and end-user can connect to the Internet 100 through a high-speed network connection such as Ethernet LAN, cable modem, DSL (“Digital Subscriber Line”) or T1/T5 line. A first specialized application server 102 handles and executes a smart agent application and is accessed by end user 104. A second specialized application server 108 handles and executes an intellectual property (IP) management database application accessed by end user computer 110, which is used by a legal outsource service provider. Specialized governmental agency server 106 is operated by a national or regional patent office as a registry of intellectual property rights.

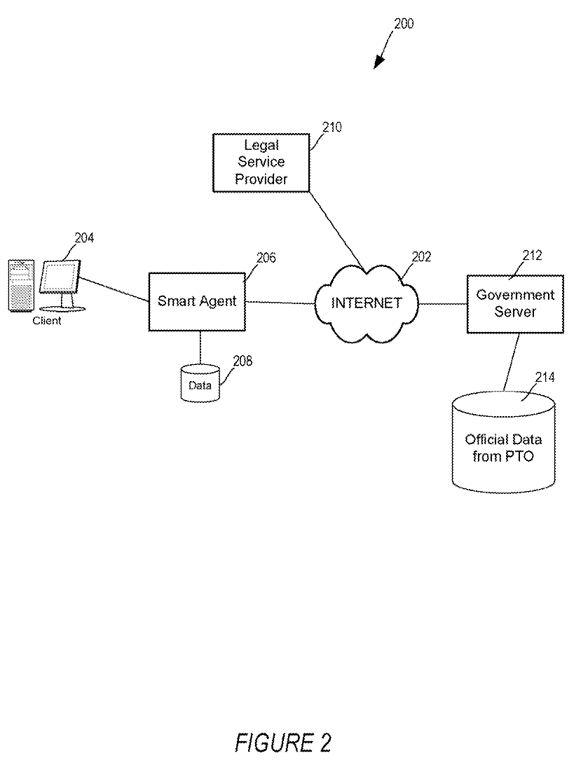

Referring to the functional network diagram in FIG. 2, a computer network system 200 implementing of the preferred embodiment is illustrated. Client computer 204 connects through a LAN or network line to smart agent application server 206. Application server 206 connects to governmental industrial property office server 212 and accesses data 214 from a patent and trademark office (“PTO”) over the public Internet 202. Each connection could be made through other known technologies such as managed network lines, and/or a private wide area networks (WAN). Software applications from a Legal Service Provider 210, such as an intellectual property law firm (IP Law), are also connected to Internet 202 and are operably connected to Smart Agent 206 and PTO data 214. Each server 206, 212 and end-user client 204 can connect to the Internet 202 through a high-speed network connection such as Ethernet LAN, cable modem, DSL (“Digital Subscriber Line”) or T1/T5 line.

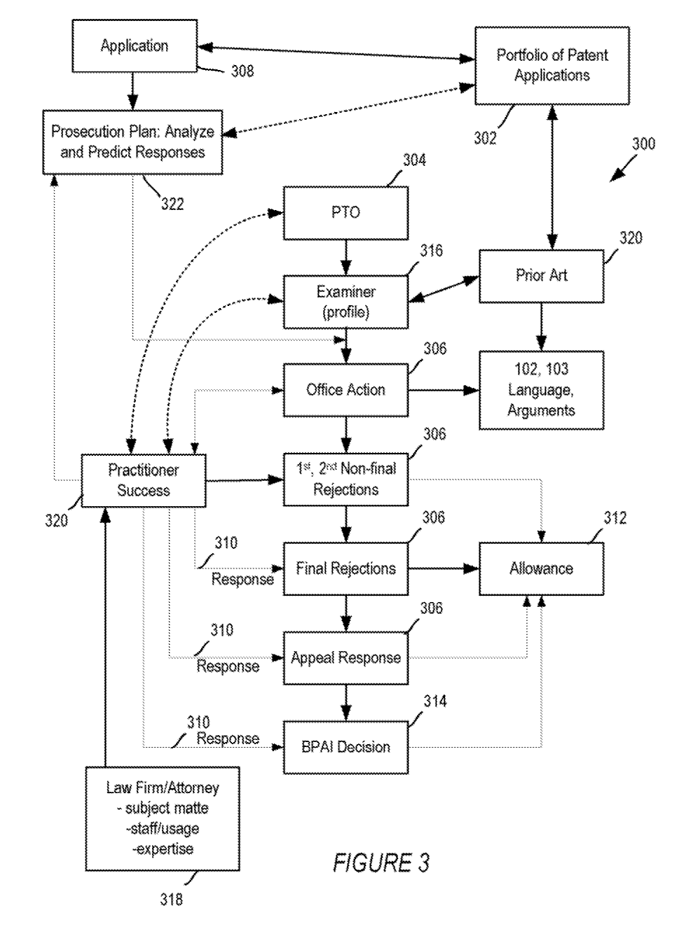

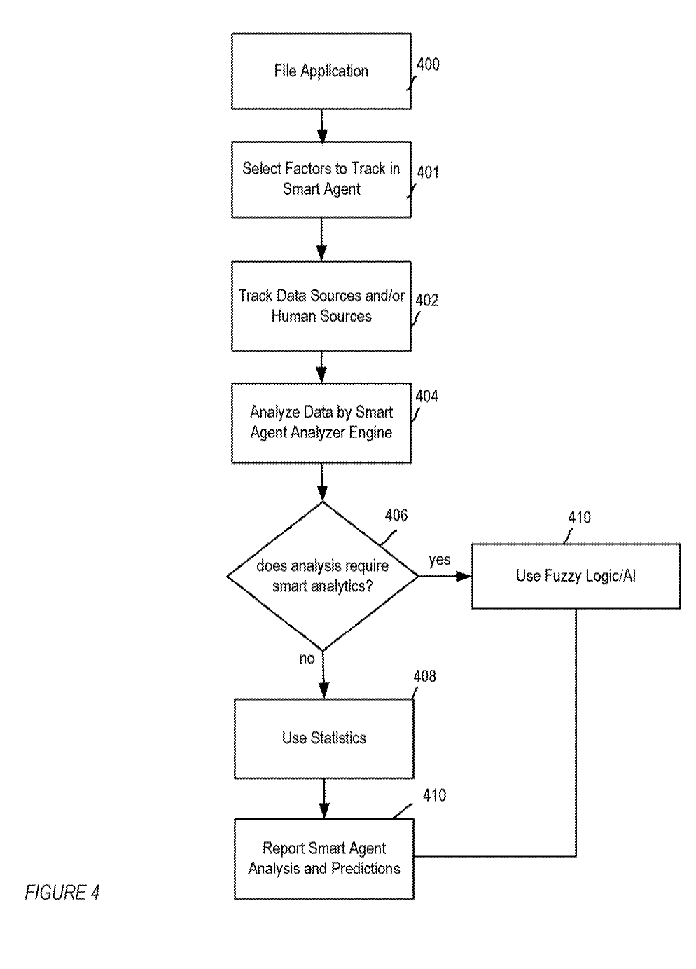

FIG. 4 is a flowchart of the method of the preferred embodiment for a smart agent analysis system. In the initial step, the user first files some type of application 400. In one embodiment illustrated in FIG. 3, the invention relates to filing and prosecuting industrial property in the form of patent applications at a patent and trademark office (PTO). Alternative embodiments include filing and prosecuting:
trademark applications with a PTO,
research grants with a government agent or private fund,
an application for capital from a fund or bank,
contract application for services or products to a government body,
petition with an government body,
substantive motion to a court or legislative body,
any private or public board, examiner, agent, representative, court, or body that substantively examines an application, motion, petition, etc. and issues a decision.

Once the application is filed 400, data factors are selected 401 to be tracked by the smart agent. The smart agent then tracks data sources and possibly human data sources 402. For example, within an applicant's portfolio 302 or within a PTO 304 as a whole, there are substantive Office Actions 306 rejecting an application 308, responses and amendments to the rejections 310, notice of allowances 312, and decisions by an appeals board 314. Certain data can be gathered from each application 308, each examiner 316, each examination group, and each patent office 304 that can be analyzed to produce a filing and prosecution strategy 322 that reduces risk of rejection and that is most advantageous to the applicant.

Actions from an examiner 316 can be profiled by types, by amendment and responses 306 from a patent attorney, by notice of allowances 312, by firms and attorney 318, by technology group, by prior art searches 320 from the applicant and from the examiner. Analyze:
how long to first office action by an Examiner, SPE, or art unit
how long between actions
if a certain attorney has more success than others against an examiner or art unit or in certain technologies
if an examiner uses the same prior art in rejecting different applicants, what are successful arguments to overcome it, what arguments fail.

In the subsequent step 404, the smart agent analyzes the collected data. The goal of the embodiments is to report 410 on the analysis which, if possible according to the data type, includes reporting predictive indicators of results based upon the application or perform a more intelligent analysis of data than has been possible using prior techniques. Depending on the data, a statistical analysis 408 such as linear regression or linear discriminate analysis, may provide adequate results. However, some data analysis may require more sophisticated techniques such as the application of artificial intelligence (Al) such as fuzzy logic 410 in a fuzzy inference system.

A fuzzy inference system (FIS) is a system that uses fuzzy logic to map one or more inputs to one or more outputs. By determining an importance of a data instance at any point in time, as compared with all other data instances, any instance may, for example, be given greater weight as a factor to be considered in reaching a desired result as opposed to other factors. Higher levels of predictions based on the selected data being tracked can also be reached using an FIS. Fuzzy logic has the advantages of the ability to model expert system comprising inputs with uncertainties that cannot be modeled with pure logic. In other words, fuzzy logic uses a system with in puts that can be true or false to a certain degree, according to membership in a set. Fuzzy systems are based on rules that may be obtained using heuristics (e.g., from a human expert), or from inferential rules based on a behavior of the system. The flexibility in which additional functionalities may be added for a process control are also advantages of the fuzzy inference system. The FIS of the present invention provides an intelligent technique for the smart agent to reach results in a superior aggregate performance of any method or system.

Fuzzy logic may be considered an extension of conventional Boolean logic in that logical values are not restricted to zero (FALSE) and one (TRUE), but rather can take on any value between zero and one inclusive. This provides greater flexibility and precision in the description process. For example, if membership in the set of “tall people” was represented with a Boolean variable, there will likely be controversy over where to set a “tall” threshold (e.g., the cutoff height for defining what is a “tall” person). On the other hand, with fuzzy logic, membership is represented by a continuum of values. One individual may receive a 0.8 membership while another individual may receive a 0.1 membership in the “tall” set.

A fuzzy inference system is a system that uses fuzzy logic to map one or more inputs to one or more outputs. The FIS used in the embodiments is based on Mamdani's fuzzy inference method, although one skilled in the art will recognize that the fuzzy method of the present invention is not limited merely to a particular fuzzy logic method. Mamdani's method uses fuzzy inference in which both the inputs and outputs are treated as fuzzy variables.

A fuzzy inference system may generally be described functionally in five steps, which are the following:
1. Fuzzification of inputs through membership functions;
2. Application of fuzzy operations as defined by the rules;
3. Implication to create fuzzy outputs for each rule;
4. Aggregation of fuzzy rule outputs; and
5. Defuzzification of aggregated fuzzy output.

The embodiments use steps one through five in the FIS. Step five, defuzzification of aggregated fuzzy output, is implemented in the embodiments because direct fuzzy outputs are used to perform analysis of selected and tracked data of an application. However, one skilled in the art will recognize that defuzzification of aggregated fuzzy output may also be implemented in the embodiments without departing from the scope of the present invention.

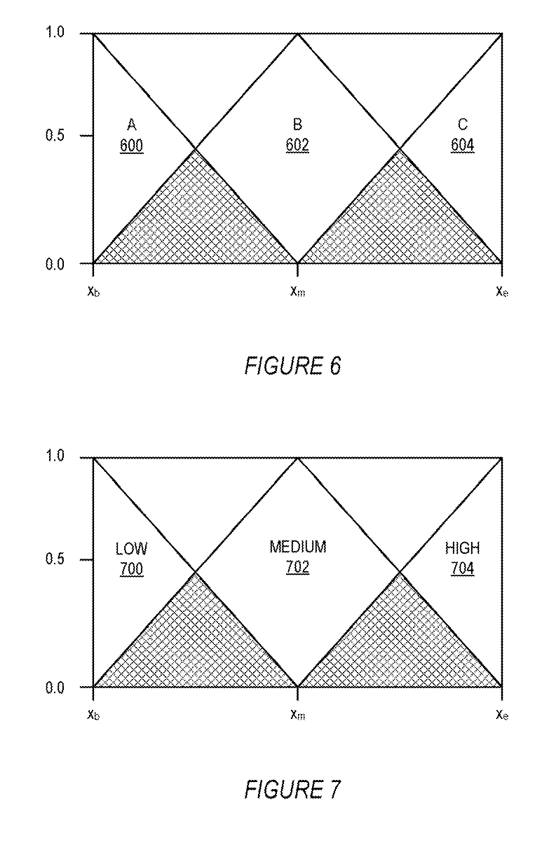

In an FIS, input membership functions provide a mapping from input values to membership within fuzzy sets. Membership always lies between zero and one inclusive. All inputs are evaluated for membership within three fuzzy sets. The three functions associated with each input variable have the same general triangular form as those displayed in FIG. 6. The values for x_{b}, xₘ, and xₑ, will be all values that vary for each group of membership functions. In FIG. 6, membership within each fuzzy set is represented by regions A (600), B (602) and C (604). The symmetry of the sets for x<xₘ and x>xₘ provides an efficient calculation of membership within each of the three sets.

For example, practitioner success data can be categorized in an FIS illustrated in FIG. 7 as three fuzzy sets of low 700, medium, 702, and high 704. The membership of the results of each data point in the practitioner's data of results in prosecuting applications with a PTO is evaluated based on the three sets. Accordingly, these membership functions map success of a practitioner in prosecution of the application. This mapping can also be considered as defining the degree to which the practitioner is successful in prosecuting an application. The lowest range of the low set 700 may be defined as an application being denied completely. The highest range of the high set 704 may be defined as having all claims allowed with no amendments. The ranges between these two values could be defined with a number of input factors such as number of claim amendments, scope of amendments, length of time of prosecution, etc, one range of which is medium 702. While is one example of the FIS application, FIS could be used to analyze near every data variable relating to an application.

An applicant can analyze his own portfolio and extrapolate to the entire art examined by the examiner and entire PTO. Instantly determine by examiner, by SPE, by art unit the types of rejections, types of office actions, the prior art, scope of searches, and success by attorneys in order to pre-write and manipulate claim language around probably rejection from an examiner.

Smart agent 104 can also analyze 404 and determine 410 patterns from an examiner and a SPE's group of examiners in an area of technology. Track:
technology area of each application
statistics of office actions in the technology
types of rejections from an examiner
Analyze rejections, time between actions, and allowances by number of claims, type (system, method, apparatus, means for) claims
track for continuations and divisionals
at what stage will an examiner most likely allow claims; after final rejection, after first rejection, after appeal, after interview, after continuation is filed

Determine patterns of success against an examiner based on the number of Request for continued examinations filed, if an appeal is filed, if length or type of claims or volume of claims are filed, how many amendments, types of amendments; does an examiner interview typically result in an allowance? This can be extrapolated to determine results from a SPE's group of Examiners, from an entire art unit, and from various technology areas of a PTO.

Analyze and profile prior art rejections; what is the success rate against 35 USC 102, 103, 112 rejections from an examiner, profile which prior art is cited the most for which type of rejection by an examiner; was the prior art found by the examiner or submitted by the applicant? Classify the area of technology against the most likely prior art to be cited by an examiner against it and what language will the examiner use to reject a type of claim. Data collection in all these areas will provide resources that allow an applicant or practitioner to make a prediction of an examiner's rejection of a claim prior to filing an application or prior to filing an amended set of claims. The smart agent can predict language of an examiners rejection based on the examiner's most likely cited prior art by comparing key words for a technology and key phrases from the examiner's prior office actions. The smart agent can analyze whether an examiner uses certain types of language and certain phrases based upon one, two, or more cited art, and when and on what types of claims are rejections maintained or withdrawn. The agent can predict reasons for or against allowance by analyzing the practitioner, the art cited, the types of responses from the applicant, the types and length of claims, reasons for rejection the claims, and the prosecution histories of successful applications that have been allowed by an examiner.

For example, if an applicant has a patent application with
a certain technology
known prior art
certain claims
certain practitioner
history of rejections from an examiner including number of amendments, continuations, interviews, arguments, reasons for allowance and profile of allowances,
   then what will be the success rate of the application against the examiner or what are the methods of prosecution that reduces risk of rejection of claims. For example, perhaps an examiner allows claims 90% of the time after an interview. This would be extremely valuable information to know, so that an applicant can schedule an interview with the Examiner. Perhaps the applicant's practitioner has a low rate of success against a particular SPE and SPE's group of examiners. This would be very valuable to know so that a practitioner with a high rate of success can be acquired. Data can be captured and analyzed to determine if an examiner is more likely than not to allow claims after an RCE is filed, or possibly after certain types of amendments, or more likely on certain types of claims. It would be valuable to know if, based on particular prior art, an examiner will always issue a final rejection and an appeal must be filed. Patterns of success and failure within a portfolio, from the applicant's side, and from an examiner from the PTO side can be merged together to produce a probability of success and failure of prosecution of an application.

Success patterns may include human factors that are not considered by applicants and practitioners, such as tone of response, length of an argument, complexity and readability of an application or response. An Examiner's rate of rejection may change over time, such as the longer she is at a PTO the lower the rate of rejection because she understands the technology better, or perhaps the rate of rejection rises because of the experience. Perhaps an Examiner has a bias against foreign companies, or translation of foreign documents, or examining applications on a certain time of the year. All of this is valuable data to collect and analyze to determine the most advantageous response or method of prosecution against an examiner. If the Examiner allows claims more often after a long and thorough response instead of short response, this would be valuable information to know in order to write a long response every time. If the Examiner gives a final rejection every time no matter what response is given, this would be valuable information in order to prepare every application for an appeal with this particular examiner.

Referring to the Examiner's substantive reasons for rejecting claims, the agent can track and analyze the language and style of the Examiner's rejections. For example, does the examiner use the same arguments in a particular area of technology and always go to final; does the examiner cite new art every time for every application; does the examiner simply quote the claim with prior art column and line number without any further reasoning? For successful applicants, what was different in their application versus ones where the examiner maintained the rejection. Maybe the Examiner always allows claims after a second non final office action or after a final office action. All of this is valuable information to analyze for predicting a rejection before the examiner receives the application.

The smart agent can also analyze an attorney's success rate 320 based on technology, data from the specification, the particular examiner, the particular PTO, against certain prior art, the type of responses she makes, etc. If a certain attorney is always successful against a certain examiner, then an applicant only needs to obtain services from that particular practitioner, thereby reducing risk of failure of the application and saving resources from having to hire other practitioners with lower success rates.

Other non-technical factors may affect prosecution of an application such as gender of an examiner or applicant, race or creed of an examiner or applicant, location of an applicant, is the applicant a foreign or national citizen from the PTO's country, is the applicant a certain type of engineer or work for a certain type of assignee? All of these factors can be analyzed by the agent to determine if there are any patterns of success or failure related to an application.

Smart agent reporting 410 can include predictions of how an examiner will respond to an application before the application is filed or soon after it is assigned to the examiner so that changes to the claims or changes in the method of prosecution can be made. Factors such as length of an application, number of figures, types of figures, length and types of claims, how the application was written can all factor into the agent's decision system. The agent can produce a range of probabilities for success relating to a technology, and art unit, a PTO, a practitioner, an applicant, and method of prosecution. This allows the application to form a smart plan 322 for the highest probability that prosecution will lead to allowance of claims.

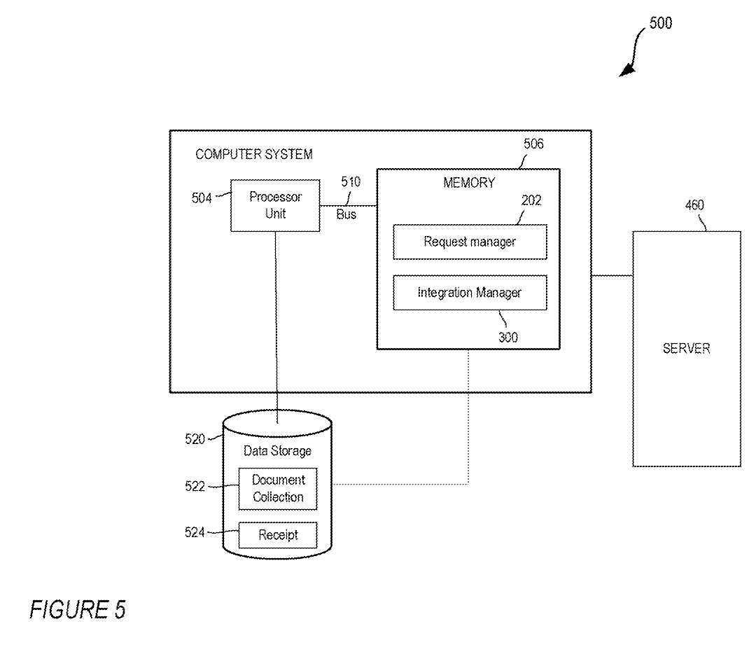

There are several underlying requirements to support the creation of the report in the manner disclosed herein. FIG. 5 is a block diagram (500) illustrating placement of the managers as hardware tools in a computer system. The illustration shows a server (502) with a processor unit (504) coupled to memory (506) by a bus structure (510). Although only one processor unit (504) is shown, in one embodiment, the computer system (502) may include more processor units in an expanded design. The computer system includes data storage (520) in communication with the server (502). The data storage unit is employed for retention of a database (522) and a collection of documents associated therewith. In one embodiment, the database is a patent management system and the documents are a collection of documents pertaining to the underlying patents and patent applications that are a part of the management system.

A query manager (524) is provided local to the memory (506) and in communication with the system (502). However, in one embodiment, the query manager may be on a remote system (not shown) that is in communication with the system (502) across a network. The query manager (524) monitors submission of queries to the database (522) retained on the data storage (520) in communication with the server (502).

A client machine (550) is provided in communication with the server (502). As with the server, the client machine is provided with a processor unit (554) coupled to memory (556) by a bus structure (560). Although only one processor unit (554) is shown, in one embodiment, the client machine (550) may include more processor units in an expanded design. An application (558) local to the client machine (550) is provided to interface with the query manager (524). The client machine (550) is provided with data storage (570) for storage of data, such as results of queries received from the server (502), and a visual display (580), for presentation of data. In one embodiment, the visual display is provided with a graphical user interface (582) to facilitate submission of queries to the database (522). As described above, the graphical user interface (582) includes fields for receiving and organizing data for query submission. More specifically, the graphical user interface (582) functions as an overlay to the underlying database. In one embodiment, the graphical user interface includes at least one field (584) to filter blocks of data, and at least a second field (586) to place a constraint on the filtered blocks of data. Following a successful submission of a query to the server (502), a report (572) is generated and retained local to the storage device (570). The report (572) is an electronic document which represents a physical/tangible document organizing data received in response to the query submission. In one embodiment, the report is returned to the data storage (570) of the client machine (550). Similarly, in one embodiment, the report is returned to the visual display (580) for presentation and use. The generated report is demonstrative of the valid submission of the query to the patent management application.

As shown herein, the query manager (524) resides in memory (506) local to the server (502), and the application manager (558) resides in memory (556) local to the client machine (550). In one embodiment, the managers (524) and (558) may reside as a hardware tool external to local memory (506), or may be implemented as a combination of hardware and software. Similarly, in one embodiment, the managers may each be separated into a plurality of components that may be collectively or individually distributed across a network and function as a unit to support query submission and report generation of a patent management tool. Accordingly, the managers (524) and (558) may be implemented as software tools, hardware tools, or a combination of software and hardware tools.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or 1/0 devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

One or more manager and/or tools are provided to support automated submission of patent related documents to a patent submission application. Due dates are monitored to ensure submission of the necessary documents to avoid payment of late fees, meeting deadlines, and/or abandonment of a pending application. Intervention by a patent practitioner is mitigated, and limited to documents that fail the submission process. Efficiency in patent prosecution is achieved and overhead is mitigated by removing the task of document submission from a patent practitioner to hardware and/or software tools.

It will be appreciated that, although specific embodiments of the invention have been described herein for purposes of illustration, various modifications may be made without departing from the spirit and scope of the invention. In particular, a unique name may be assigned to one of the blocks of data employed in the executed query. Accordingly, the scope of protection of this invention is limited only by the following claims and their equivalents.

What is claimed:

1. A method for smart prosecution of an application, comprising:
analyzing a history of responses from an examiner;
analyzing an objective factor related to the examiner's prior work on other applications; and
determining a factor from the analyzing steps that provides an applicant with a higher probability of success with the application.

2. A method for analyzing factors relating to an application, comprising:
identifying, for said application, a data factor that has a potential influence upon said application; and
determining, with a smart system, an importance of the data factor.

3. The method of claim 2, wherein the determining, with a smart system, an importance includes determining an importance with a fuzzy inference system.

4. The method of claim 2, wherein the determining, with a smart system, an importance includes determining an importance with a stastical analysis.
